(19) United States
(12) Patent Application Publication
(10) Pub. No.: US 2004/0088421 A1
(43) Pub. Date: May 6, 2004

(54) Controlling facility for a group of access devices

(76) Inventor: John Huang, Hsin Chuang City (TW)

Correspondence Address: John Huang, P.O. Box 4-67, Hsin Chuang, Taipei, 242, TW

(21) Appl. No.: 10/287,619

(22) Filed: Nov. 1, 2002

(51) Int. Cl. G06F 15/16

(52) U.S. Cl. 709/229

(57) ABSTRACT

A controlling facility for a network system includes a processor unit having a detecting device to detect and to check identification of end users and to determine whether the end users are acceptable or qualified or not. One or more comparing devices may be used to compare data of the end users and to determine whether the end users are busy or not. An operating device may be used to reject the unbusy end users and to couple the end users to unused access device, for allowing the transmitting operation to be conducted more fluently or smoothly.

### BACKGROUND OF THE INVENTION

1. Field of the Invention

The present invention relates to a controlling facility, and more particularly to a controlling facility for controlling a number of or a group of access devices.

2. Description of the Prior Art

Typical controlling facilities have been developed for allowing the end users, such as the personal computers or the notebook computers, to be communicated with the local network systems, and may include a number of access devices disposed or provided within a wireless network area or zone.

The end users may be accepted to enter into the local area network (LAN) system after the service set identifiers (SSID) or the identifications and/or the institute of electrical and electronic engineers (IEEE) of the end users have been checked or detected or confirmed.

Normally, the end users may be coupled to or communicated with the nearest access device that are provided closer to the end users, such that some of the access devices may be crowded with end users or will be very busy and may not accept a number of end users simultaneously, such that the working flow rate may be seriously decreased.

The present invention has arisen to mitigate and/or obviate the afore-described disadvantages of the conventional controlling facilities.

### SUMMARY OF THE INVENTION

The primary objective of the present invention is to provide a controlling facility for controlling a number of or a group of access devices, and for preventing the end users from concentrating in one or few access devices.

The other objective of the present invention is to provide a controlling facility for allowing the data or signals to be uniformly or equally communicated with either of the access devices, particularly the unused access devices.

In accordance with one aspect of the invention, there is provided a controlling facility for a network system, the controlling facility comprising a processor unit including a detecting device to detect and to check identification of end users, and to determine whether the end users are acceptable or qualified or not, a first comparing device to compare data of the end users, and to determine whether the end users are busy or not, and an operating device to reject the end users and to couple the end users to unused access device.

The detecting device is provided for detecting whether the end users is in the same network system or not, and/or for transmitting and communicating the data of the end users when the end users are qualified, and/or for detecting whether the end users is busy or not.

The first comparing device is provided for transmitting and communicating the data or the information of the end users when the end users are determined to be busy.

A second comparing device may further be provided and coupled between the first comparing device and the operating device, for transmitting and communicating the data of the end users when the end users are determined to be busy.

The operating device is provided to reject the end users when the end users are determined to be unbusy, and/or to determine whether the end users is qualified or not.

A protecting device may further be provided to receive data from the end users when the network system is closed, and/or to determine whether the end users is qualified or not, and/or to transmit and communicate the data of the end users when the end users are determined to be busy.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a block diagram illustrating processes to be conducted or operated with a controlling facility in accordance with the present invention;

FIG. 2 is a block diagram illustrating the processes to be conducted or operated with a detecting device of the controlling facility;

FIG. 3 is a block diagram illustrating the processes to be conducted or operated with one or more comparing devices of the controlling facility;

FIG. 4 is a block diagram illustrating the processes to be conducted or operated with an operating device of the controlling facility; and

FIG. 5 is a block diagram illustrating the processes to be conducted or operated with a protecting device of the controlling facility.

### DETAILED DESCRIPTION OF THE PREFERRED EMBODIMENT

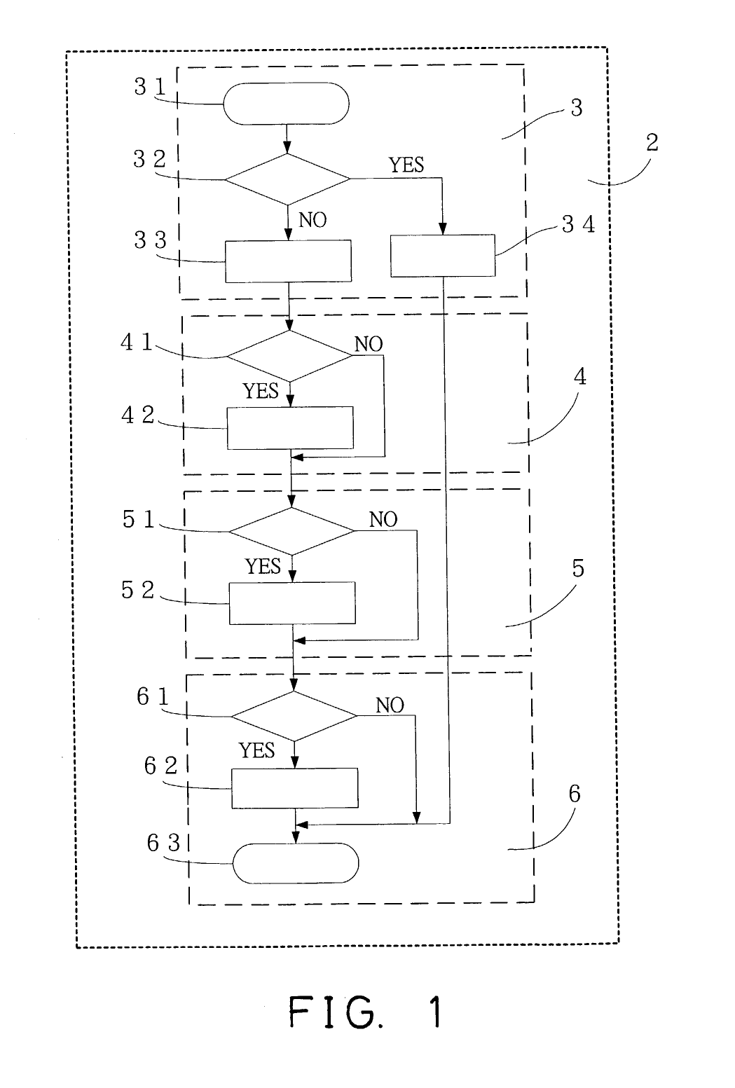

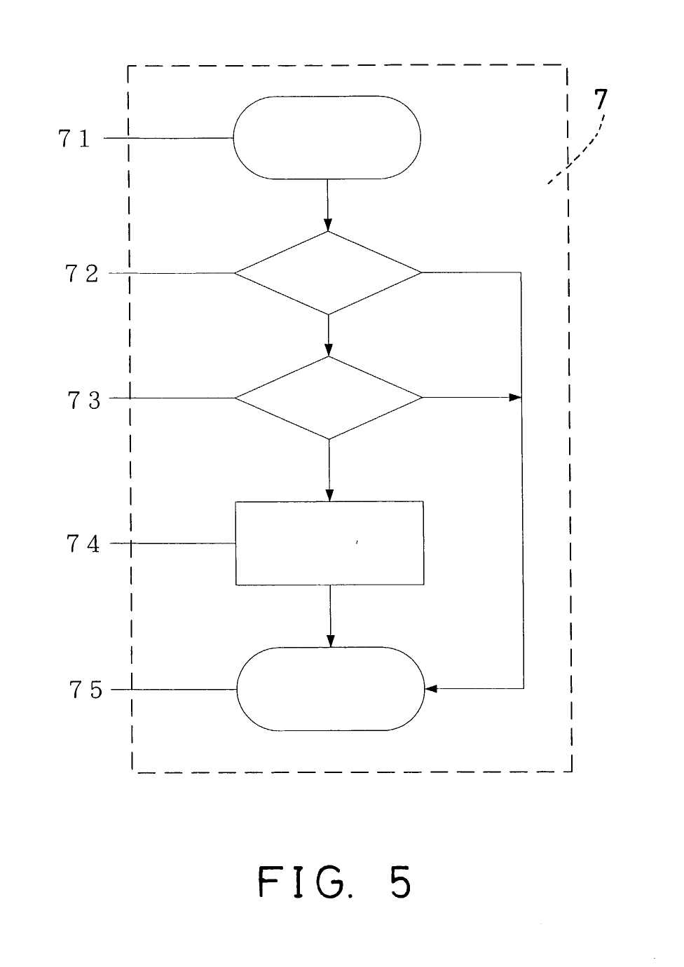

Referring to the drawings, and initially to FIG. 1, a controlling facility in accordance with the present invention may be one or more access devices, and comprises a processor unit 2 including a detecting device 3, a first and a second comparing devices 4, 5, and an operating device 6. The processor unit 2 may further include a protecting device 7 as shown in FIG. 5.

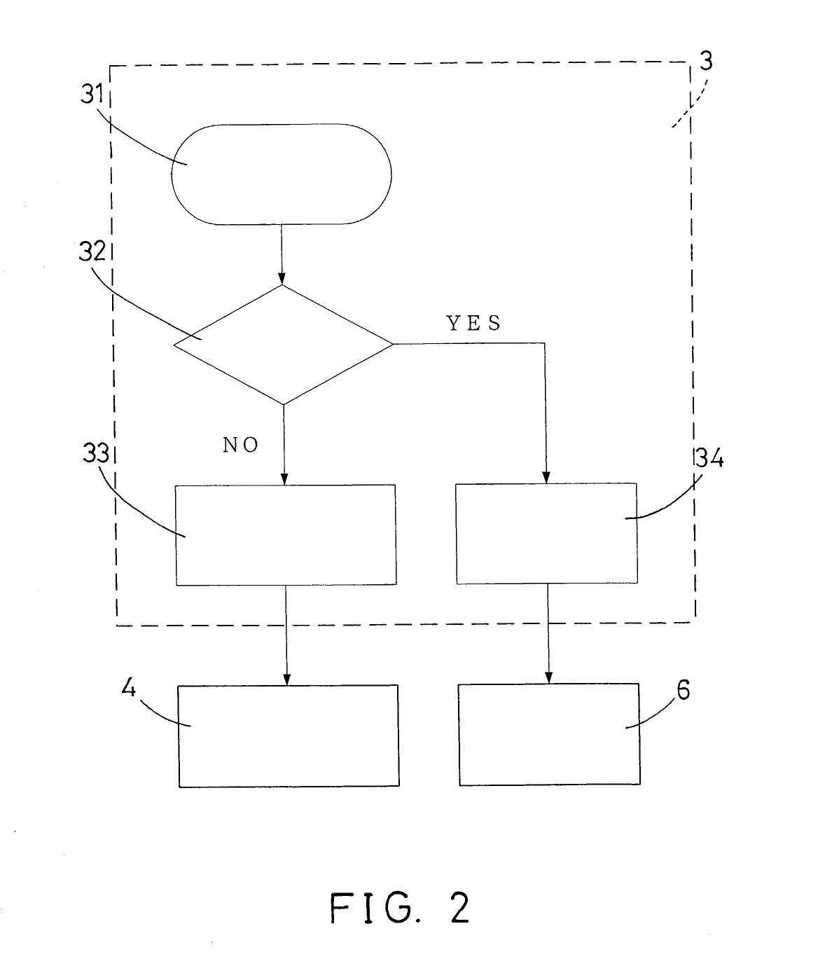

Referring next to FIG. 2, and again to FIG. 1, the detecting device 3 may be provided for periodically detecting the signals or data or information in the access devices or in the controlling facility, in process 31, for detecting or determining whether the signals are coming from the same group of the access devices or whether the end users are in the same group of the access devices or are in the same network system or not.

For example, when the signals are coming from the same group of the access devices or from the same network system, the processor unit 2 may start to send or communicate or transmit the data or information or signals. On the contrary, when the signals are detected to be not from the same group of the access devices, the detecting device 3 may detect or calculate whether the data transmission is busy or not, and may determine wither to communicate or to transmit the data or information or signals or not.

For example, when the transmission of the data or information in the access devices has been detected or calculated to be busy by the detecting device 3, the detecting device 3 or the processor unit 2 may determine not to communicate or to transmit the data or information or signals, and may have the following end users to wait in line.

The detecting device 3 may be provided for periodically detecting the signals or data or information in the access devices or in the controlling facility, one time in such as five (5) seconds, and may start the process 32 when receiving one or more institute of electrical and electronic engineers (IEEE) signals from various end users.

In process 32, the detecting device 3 may detect or check the IEEE frequencies, the service set identifiers (SSID) or the identifications and/or the internet protocol (IP) of the end users, to detect or determine whether the end users are from the known modules or manufactures or models or are acceptable or are qualified or not.

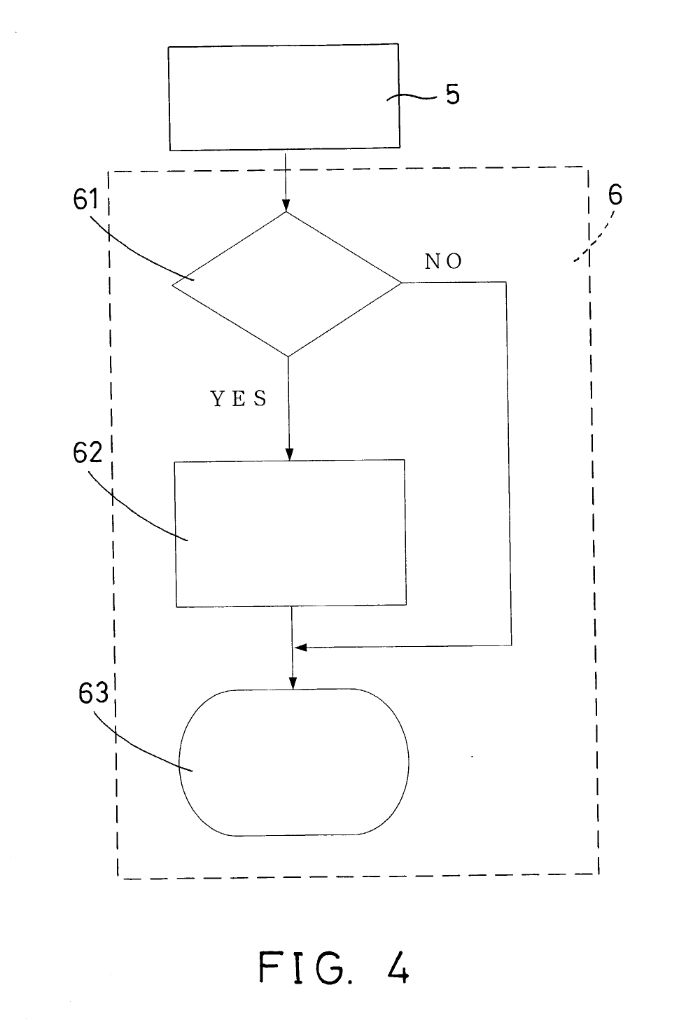

If the end users are detected or determined to be from the known modules or manufactures or models or are acceptable or qualified, the detecting device 3 may conduct or operate the linking or communicating or transmitting process 34 in order to transmit or to communicate the data or information or signals of the end users with the other access devices or network systems, and may then move to the operating device 6 (FIGS. 1, 4).

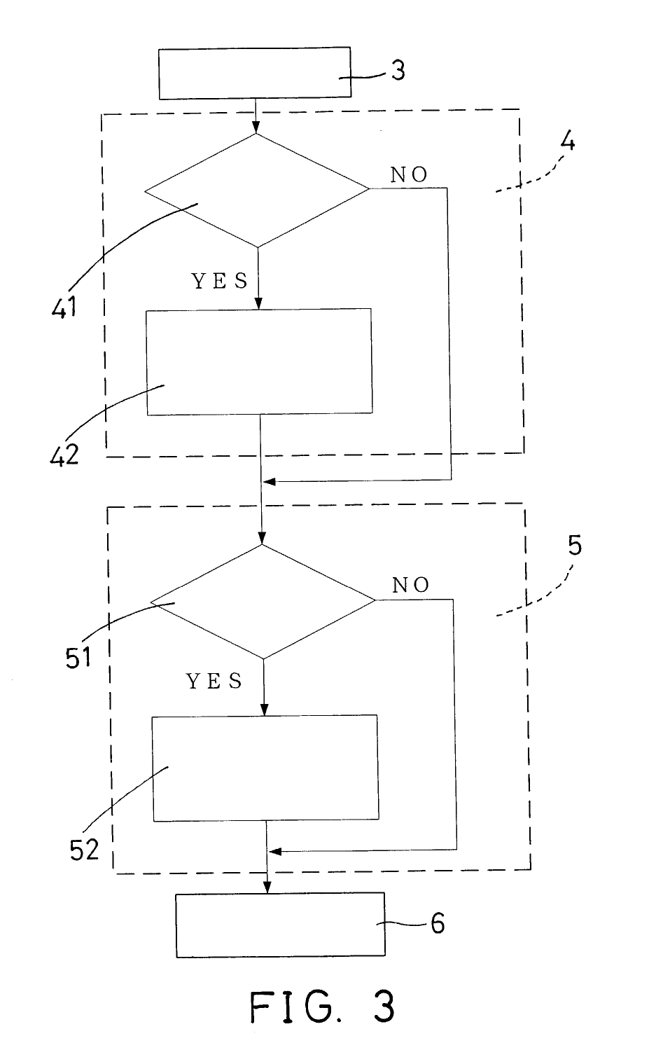

On the contrary, when the end users have been detected or determined not to be from the known modules or manufactures or models or unacceptable or unqualified, the detecting device 3 may conduct or operate the examining process 33 in order to check or to examine whether the transmission of the data or information or signals of the end users is busy or not, and may then move to the first comparing device 4 (FIGS. 1, 3).

In the examining process 33, the detecting device 3 may check or examine whether the transmission of the data or information or signals from the end users is busy or not, by calculating the numbers or routes of the transmitters and the receivers of the end users or the data or information transmitted by the end users, in order to determine the data transmission condition value which will then be sent to the first comparing device 4 (FIGS. 1, 3).

Referring next to FIG. 3, and again to FIG. 1, the first comparing device 4 will then conduct or operate the transmitting flow rate or value comparing process 41 in order to check or to examine the value of the transmission flow rate of the end users or to check whether the end users are busy or not.

When the value of the transmitting flow rate of the end users is determined to be high, or when the volume of the information or data of the end users is huge, or when a longer time is required to transmit or to communicate the data or information of the end users, the end users are allowed to enter into or to conduct the linking or communicating or transmitting process 42 in order to transmit or to communicate the data or information or signals with the other access devices or network systems.

On the contrary, when the value of the transmitting flow rate of the end users is determined to be low, or when the volume of the information or data of the end users is small, or when a shorter time is required to transmit or to communicate the data or information of the end users, the end users may bypass the linking or communicating or transmitting process 42 and may not transmit the data and may be directly sent or coupled to the second comparing device 5.

The end users that are not in a hurry may be prevented from occupying the transmitting line, for allowing the busier end users to use or to transmit the data first, and thus for preventing the transmitting lines or paths from being occupied by the other unnecessary data or information, and thus for allowing the transmitting operation to be conducted more fluently or smoothly.

Similarly, the second comparing device 5 will then conduct or operate the transmitting flow rate or value comparing process 51 in order to check or to examine the value of the transmission flow rate of the end users.

When the value of the transmitting flow rate of the end users is determined to be high, or when the volume of the information or data of the end users is huge, or when a longer time is required to transmit or to communicate the data or information of the end users, the end users may also be allowed to enter into or to conduct the linking or communicating or transmitting process 52 in order to transmit or to communicate the data or information or signals with the other access devices or network systems.

On the contrary, when the value of the transmitting flow rate of the end users is determined to be low, or when the volume of the information or data of the end users is small, or when a shorter time is required to transmit or to communicate the data or information of the end users, the end users may not transmit the data and may be directly sent or coupled to the operating device 6.

The end users that are not in a hurry may also be prevented from occupying the transmitting line, for allowing the busier end users to use or to transmit the data first, and thus for preventing the transmitting lines or paths from being occupied by the other unnecessary data or information, and thus for allowing the transmitting operation to be conducted more fluently or smoothly.

The operating device 6 may conduct or operate the checking or inspecting or examining process 61 repeatedly or periodically once per sixty (60) seconds, for example, in order to examine whether the linking end users are qualified or not.

For example, when the flow rates, the frequency converting techniques, the frequencies or the like of the end users are incorrect or wrong or are not qualified, or when the flow rate of the end users is low, the end users may then be directed to the eliminating or removing or rejecting process 62, in order to end or to remove or to cut the unbusy end users from transmission, and may then move to the end process 63

The processor unit 2 of the access devices may also force the end users to enter into or to couple with the other unused access devices, for preventing the other access devices from being left unused, and for allowing the transmitting operation to be conducted more fluently or smoothly.

After the end process 63 conducted by the operating device 6, the processor unit 2 may call the detecting device 3 to conduct the detecting process 31 again, in order to periodically detect the signals or data or information in the access devices or in the controlling facility, and for detecting or determining whether the signals are coming from the same group of the access devices.

Referring next to FIG. 5, the protecting device 7 may be energized or actuated or operated when the processor unit 2 of the access device is in a working condition or status, and may conduct or operate the receiving process 71 to continuously receive the signals or data or information from the end users, even when the network system or the access device is closed or shut off, and may send the signals or data or information from the end users to the transmission detecting process 72.

For example, when the number of the transmission of the end users is less then five (5) times, the signals or data or information from the end users may be directly sent to the end process 75 in order to end or to remove or to cut the unbusy end users from transmission. The processor unit 2 of the access devices may also force the end users to enter into or to couple with the other unused access devices, for preventing the other access devices from being left unused, and for allowing the transmitting operation to be conducted more fluently or smoothly.

On the contrary, when the number of the transmission of the end users is more then five (5) times, the signals or data or information from the end users may then be sent to the operating process 73 in order to check whether the end users is acceptable or qualified or not, and may then be sent to the end process 75 if the end users is not acceptable or is not qualified.

If the end users has been checked or determined to be acceptable or to be qualified, the end users may then enter into or conduct the linking or communicating or transmitting process 74 in order to transmit or to communicate the data or information or signals with the other access devices or network systems.

In operation, the unbusy end users may be prevented or removed from linking by the comparing devices 4 and/or 5, and/or by the operating device 6, and/or by the protecting device 7, and/or may be forced to enter into or to couple with the other unused access devices, for preventing the other access devices from being left unused, and for allowing the transmitting operation to be conducted more fluently or smoothly.

Accordingly, the controlling facility in accordance with the present invention may be used for controlling a number of or a group of access devices, and for preventing the end users from concentrating in one or few access devices, and for allowing the data or signals to be uniformly or equally communicated with either of the access devices, particularly the unused access devices.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A controlling facility for a network system, said controlling facility comprising:
a processor unit including:
a) a detecting device to detect and to check identification of end users, and to determine whether the end users are acceptable or qualified or not,
b) a first comparing device to compare data of the end users, and to determine whether the end users are busy or not, and
c) an operating device to reject the end users and to couple the end users to unused access device.

2. The controlling facility according to claim 1, wherein said detecting device is provided for detecting whether the end users is in the same network system or not.

3. The controlling facility according to claim 1, wherein said detecting device is provided for transmitting and communicating the data of the end users when the end users are qualified.

4. The controlling facility according to claim 1, wherein said detecting device is provided for detecting whether the end users is busy or not.

5. The controlling facility according to claim 1, wherein said first comparing device is provided for transmitting and communicating the data of the end users when the end users are determined to be busy.

6. The controlling facility according to claim 1 further comprising a second comparing device coupled between said first comparing device and said operating device.

7. The controlling facility according to claim 6, wherein said second comparing device is provided for transmitting and communicating the data of the end users when the end users are determined to be busy.

8. The controlling facility according to claim 1, wherein said operating device is provided to reject the end users when the end users are determined to be unbusy.

9. The controlling facility according to claim 1, wherein said operating device is provided to determine whether the end users is qualified or not.

10. The controlling facility according to claim 1 further comprising a protecting device provided for receiving data from the end users when the network system is closed.

11. The controlling facility according to claim 10, wherein said protecting device is provided to determine whether the end users is qualified or not.

12. The controlling facility according to claim 10, wherein said protecting device is provided for transmitting and communicating the data of the end users when the end users are determined to be busy.
